(19) United States
(12) Patent Application Publication
(10) Pub. No.: US 2017/0189837 A1
(43) Pub. Date: Jul. 6, 2017

(54) Filter System and Filtration Method for Fluid Reservoirs

(71) Applicant: Caterpillar Inc., Peoria, IL (US)

(72) Inventors: Shawn Herold, East Peoria, IL (US); Matthew F. Fahrenkrug, Chillicothe, IL (US); Jason W. Hudgens, Washington, IL (US); Theron J. Cassidy, Peoria, IL (US)

(73) Assignee: Caterpillar Inc., Peoria, IL (US)

(21) Appl. No.: 14/989,492

(22) Filed: Jan. 6, 2016

(51) Int. Cl. B01D 35/027; B01D 29/27

(52) U.S. Cl. CPC B01D 35/0276; B01D 29/27; B01D 53/9418

(57) ABSTRACT

A fluid reservoir for accommodating a fluid reductant used in an SCR exhaust treatment process may include various styles or designs of bag filters to filter debris and contaminants from the reductant prior to being channeled out of the reservoir. To secure the bag filter to a header assembly accommodating the various inlet and outlet tubes, in one aspect, the bag filter is adapted to fit around a header boss descending from the header assembly and protruding into the reservoir volume. Various configurations for the bag filter can be utilized to secure the bag filter to the header boss in a manner that isolates the tubes of the header assembly from the remainder of the reservoir volume to prevent debris and the like from being unintentionally drawn out of the reservoir.

### TECHNICAL FIELD

This disclosure relates generally to diesel exhaust fluid delivery systems used in association with engine emission control systems and, more particularly, to a filter system and filtration method for use with reductant agent delivery systems.

### BACKGROUND

One known method for abating certain diesel engine exhaust constituents is by use of an exhaust after-treatment system that utilizes Selective Catalytic Reduction (SCR) of nitrogen oxides. In a typical SCR system, a fluid reductant or reducing agent, sometimes referred to as diesel exhaust fluid (DEF) and which may include urea or a urea-based water solution, is mixed with exhaust gas before being provided to an appropriate catalyst. In some applications, the reductant is injected directly into an exhaust passage through a specialized injector device. In the case of urea, the injected reductant mixes with exhaust gas and breaks down to provide ammonia (NH₃) in the exhaust stream. The ammonia then reacts with nitrogen oxides (NOₓ) in the exhaust at a catalyst to provide nitrogen gas (N₂) and water (H₂O).

As can be appreciated, SCR systems require the presence of some form of reductant sufficiently close to the engine system such that the engine can be continuously supplied during operation. Various reductant delivery systems are known and used in engine applications. In known reductant injection systems, a reservoir is installed onto a vehicle for containing the reductant, which is drawn from the reservoir and delivered in metered amounts to the engine exhaust system. The reservoir has a finite urea capacity such that periodic replenishment of the reductant within the reservoir is required. In certain applications, such as mining, construction, farming and other field applications, reductant replenishment may be carried out in the work environment of the machine. Such refilling or replenishment operations are typically carried out by dispensing reductant into the reservoir through a removable reservoir cap. As can be appreciated, dirt and other debris may fall within the reservoir, especially during a refilling operation, which may present problems if the dirt and/or other debris is ingested into a pump drawing reductant from the reservoir, and/or is delivered with the reductant to the reductant injector, which typically has close clearances and small injection orifices that can bind or become plugged by the debris.

In the past, various solutions have been proposed to mitigate the presence of debris within a reductant reservoir. Most such solutions propose adding filtering media to a fill opening of the reservoir, or adding filters in line with a reductant supply line within the system at a location upstream of a reductant pump and/or before the reductant injector. However, such known solutions present certain challenges. For example, a filter disposed at an inlet of the container may impede the rapid filling of the container, which is desired, especially since a lengthy filling process may rob the machine of profitable time in service. Moreover, the aqueous components of reductant fluids are susceptible to thermal effects such as breakdown at high temperatures or freezing at low temperatures, which makes their presence in lengthy in-line supply conduits and/or filters undesirable due to crystallization effects and/or freezing within the filter. Such conditions, which require the addition of heaters and/or other temperature control devices to be added to reductant supply systems, increase the cost and complexity of those systems.

### SUMMARY

The disclosure describes, in one aspect, a bag filter disposable in a reservoir for filtration of a liquid reductant contained in the reservoir. The bag filter can include a support ring of relatively rigid material and a filter sock of filtration material having relatively pliable characteristic compared to the support ring. The filter sock has an elongated configuration including a closed end, an oppositely disposed opened end, and a tubular portion extending between the closed end and the opened end. The opened end delineates a bag opening and includes a hem of filtration material folded over the support ring and attached to the tubular portion to secure the support ring to the bag filter.

In another aspect, the disclosure describes a reservoir for liquid reductant used in exhaust gasses treatment. The reservoir includes a reservoir body delineating a reservoir volume. To receive a header in which supply and return tubes are arranged, the reservoir further include a header opening that is delineated by a reservoir rim that forms a shoulder-like structure at the intersection of the reservoir exterior and the reservoir rim. The header assembly includes a header having a header flange and a header boss protruding from the header flange that corresponds in shape to and is receivable in the header opening. A bag filter includes a support ring and a filter sock of filtration material having a closed end and an opened end delineating a bag opening. Formed around the bag opening can be a hem of filtration material that is folded over the support ring and attached back to filter sock. The support ring and the bag opening are configured to fit closely about the header boss for disposal between the reservoir rim and the header flange to secure the bag filter to the header assembly.

In yet another aspect, the disclosure describes a filter flange/bag filter combination for insertion into a reservoir containing reductant fluid for exhaust gas treatment. The bag filter/filter flange includes a filter flange having a sleeve frame cylindrical in shape and delineating central bore and an axis line. The filter flange further includes an annular flange extending perpendicularly from a first end of the sleeve frame and concentric to the central bore. The filter flange/bag filter combination further includes bag filter of pliable filtration material having a closed end and an opened end disposed opposite the closed end. To assembly the filter flange/bag filter combination, the opened end of the bag filter delineates a bag opening that is attached to the cylindrical sleeve.

### BRIEF DESCRIPTION OF THE DRAWINGS

FIG. 1 is a schematic block diagram of an internal combustion engine coupled to various exhaust aftertreatment systems including an SCR system in accordance with the disclosure.

FIG. 2 is a perspective view of a reductant reservoir for accommodating a fluid reductant agent isolated from the SCR system of FIG. 1.

FIG. 3 is a cross-sectional elevational view of the reductant reservoir taken along line 3-3 of FIG. 2 and illustrating the internal components of the reservoir.

FIG. 4 is a perspective view of a header assembly accommodating the fluid inlets and outlets of the reductant reservoir, the header assembly having a bag filter attached thereto and adapted to be partially inserted into the reservoir.

FIG. 5 is a cross-sectional view of a reservoir with a portion of the bag filter disposed between the interface of the header assembly and the reservoir flange.

FIG. 6 is perspective view of an embodiment of the bag filter with a support ring hemmed into the opened end of the bag filter and adapted to suspend the bag filter in the reservoir.

FIG. 7 is a perspective view of the support ring including a radial gap designed to enable the support ring to radially contract and expand.

FIG. 8 is a cross-sectional view of the bag filter and the gasket of FIG. 6 disposed between an interface of the reservoir and the header assembly when assembled together.

FIG. 9 is a perspective view of the bag filter of FIG. 7 disposed in a reservoir/header opening of the reservoir with a gasket concentrically place around the opened end of the bag filter.

FIG. 10 is a perspective view of a filter flange having a top-hat shape or outline that may be included as part of the bag filter to secure the bag filter in the reservoir.

FIG. 11 is a perspective view of the filter flange of FIG. 10 secured to the bag filter that descends from the filter flange.

FIG. 12 is a sectional view of a reservoir with the filter flange disposed at the interface between the header assembly and the reservoir embossment with the bag filter disposed inside the reservoir volume.

FIG. 13 is a perspective view of another embodiment of the top-hat shaped filter flange with a sleeve frame that lacks the plurality of windows included as part of the bag filter and secure within the bag opening.

FIG. 14 is a perspective view of another embodiment of the filter flange having a top hat shape to be included as part of the bag filter.

FIG. 15 is a perspective view of the filter flange of FIG. 14 as attached to the bag filter with descends from the filter flange.

FIG. 16 is a cross-sectional view of the filter flange of FIG. 15 attached to the bag filter and disposed at the interface between the reservoir and the header assembly.

FIG. 17 is a cross-sectional view of a filter flange similar FIG. 15 and attached to the bag filter where the cylindrical sleeve is disposed in an oppositely directed orientation with respect to the reservoir and bag filter.

### DETAILED DESCRIPTION

This disclosure relates to emission control systems for machines and, more particularly, to reductant filtering systems for use with SCR-based after-treatment systems for diesel engines used on stationary or mobile machines. The machines contemplated in the present disclosure can be used in a variety of applications and environments. For example, any machine that performs some type of operation associated with an industry such as mining, construction, farming, transportation, marine or any other industry known in the art is contemplated. For example, the type of machine contemplated herein may be an earth-moving machine, such as a wheel loader, excavator, dump truck, backhoe, material handler, locomotive, paver or the like. Apart from mobile machines, the machine contemplated may be a stationary or portable machine such as a generator set, an engine driving a gas compressor or pump, and the like. Moreover, the machine may include or be associated with work implements such as those utilized and employed for a variety of tasks, including, for example, loading, compacting, lifting, brushing, and include, for example, buckets, compactors, forked lifting devices, brushes, grapples, cutters, shears, blades, breakers/hammers, augers, and others.

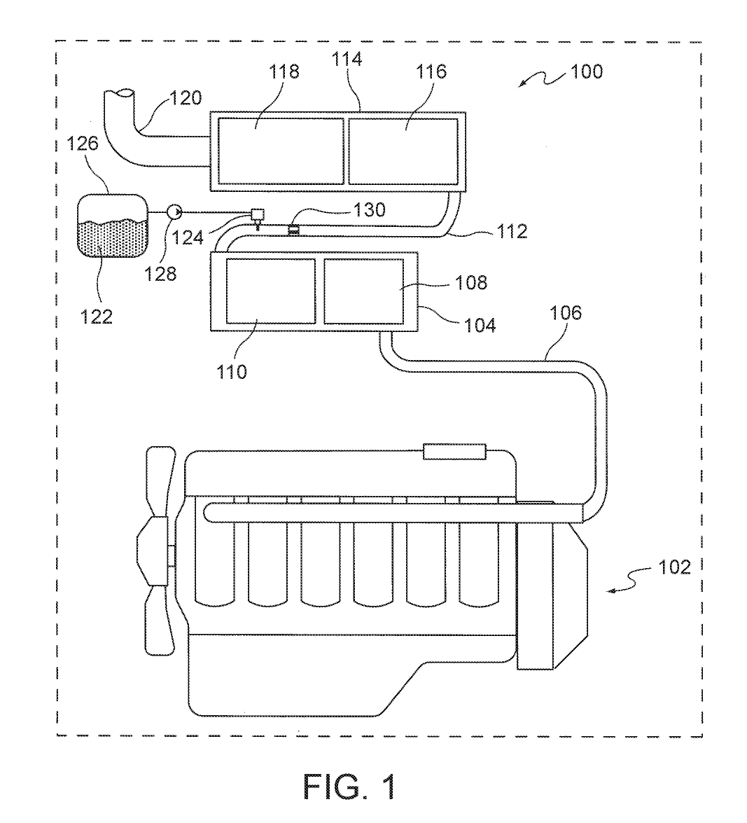

Now referring to the drawings, wherein like reference numbers refer to like elements, there is illustrated in FIG. 1 a representative block diagram of an exhaust aftertreatment system 100 associated with an internal combustion engine 102 of a machine. The internal combustion engine 102 is designed to combust a hydrocarbon-based fuel such as diesel or gasoline and convert the potential chemical energy therein to mechanical power in the form of rotational motion. In the illustrated embodiment, the engine may be a compression ignition diesel engine, but in other embodiments may be a spark ignition gasoline engine, a gas turbine, etc. The aftertreatment system 100 may be modularly packaged as shown in the illustrated embodiment for retrofit onto existing engines or, alternatively, for installation on new engines. In the illustrated embodiment, the aftertreatment system 100 includes a first aftertreatment module 104 that is fluidly connected to an exhaust conduit 106 from the engine 102. During engine operation, the first module 104 is arranged downstream of the engine 102 to internally receive engine exhaust gas from the conduit 106. The first aftertreatment module 104 may contain various exhaust gas treatment devices such as a diesel oxidation catalyst (DOC) 108 and a diesel particulate filter (DPF) 110, but other devices may be used. The first aftertreatment module 104 and the components found therein are optional and may be omitted for various engine applications in which the exhaust-treatment function provided by the first module 104 is not required. In the illustrated embodiment, exhaust gas provided to the first module 104 by the engine 102 may first pass through the DOC 108 and then through the DPF 110 before entering a transfer conduit 112.

The transfer conduit 112 fluidly interconnects the first aftertreatment module 104 with a second aftertreatment module 114 such that exhaust gas from the engine 102 may pass through the first and second aftertreatment modules 104 and 114 in series before being released to the environment from a stack 120 that is connected to the second aftertreatment module. In the illustrated embodiment, the second aftertreatment module 114 encloses a SCR catalyst 116 and an Ammonia Oxidation Catalyst (AMOX) 118. The SCR catalyst 116 and AMOX 118 operate to treat exhaust gas from the engine 102 in the presence of ammonia, which is provided after degradation of a fluid or liquid reductant agent or reductant injected into the exhaust gas in the transfer conduit 112.

More specifically, the fluid or liquid phase reductant 122 may be a urea-containing water solution, which may be commonly referred to as diesel exhaust fluid (DEF), that is injected into the transfer conduit 112 by a reductant injector 124. The reductant 122 is contained within a tank-like reservoir 126 and is provided to the reductant injector 124 by a pump 128. As the reductant 122 is injected into the transfer conduit 112, it mixes with exhaust gas passing therethrough and is transferred therewith to the second aftertreatment module 114. To promote mixing of reductant with the exhaust gas, a mixer 130 comprised of baffles may be disposed along the transfer conduit 112. As can be appreciated, the location of the reductant injector 124 on the transfer conduit 112 can expose the injector to relatively high temperatures due to heating from exhaust gas during operation. In the illustrated exemplary embodiment, a flow of engine coolant is provided through the injector, but such coolant flow is optional.

One issue that may arise during operation is ingestion of dirt and/or other debris that may be found within the reservoir 126. Because urea may freeze, the inlet port within the reservoir 126 and other similar reservoirs is close to the bottom of the reservoir such that liquid urea may be drawn even if frozen urea is still present and floating in the reservoir when operation of the engine 102 starts and a heater disposed within the reservoir has not yet melted the entire amount of urea held in the reservoir. However, drawing liquid from the bottom of the reservoir 126 for this reason also makes the system more susceptible to ingestion of debris, dirt or other contaminants that may be present within the reservoir, for example, by falling into the reservoir through a fill-port opening during a filling operation.

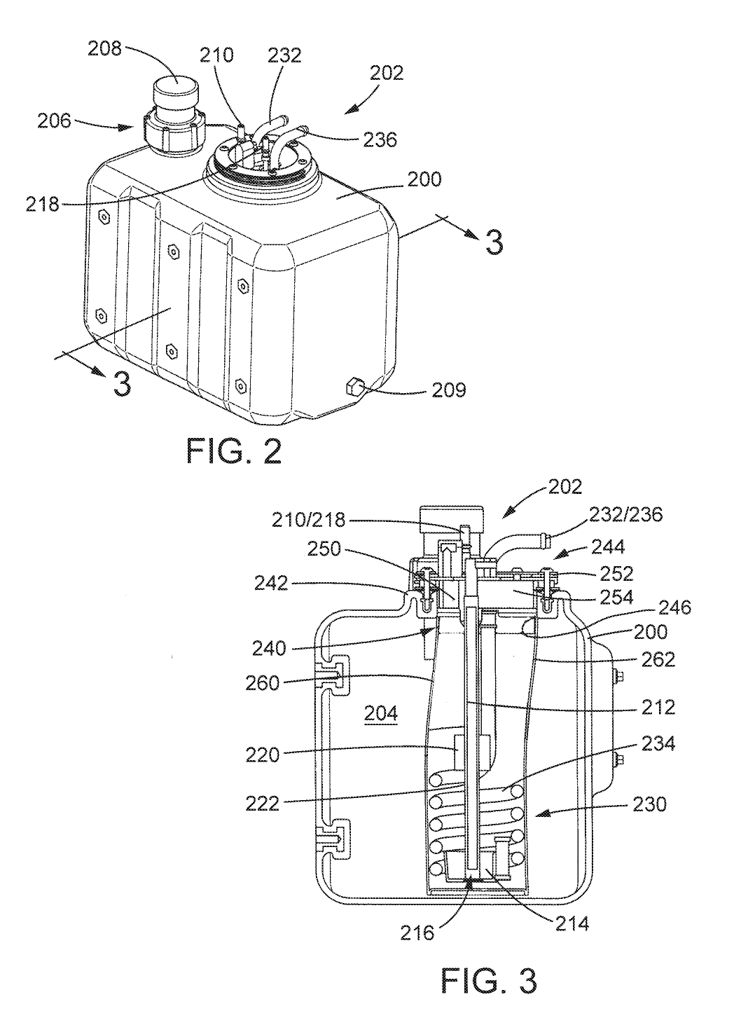

To accommodate the fluid reductant, a more detailed embodiment of the reservoir 200 is illustrated in FIGS. 2 and 3. To communicate the fluid reductant to the SCR system of the second aftertreatment module, the reservoir 200 includes a header assembly 202 installed on the top of the reservoir that is configured with various inlet and outlet tubes. The reservoir 200 shown is a single-piece molded plastic structure that forms a reservoir body defining a generally hollow, internal reservoir volume 204 of suitable volume to hold a quantity of reductant for sustained treatment of the exhaust gasses. To fill the reservoir 200 with fluid reductant, the reservoir volume can be accessed through a fill opening 206 disposed through the reservoir body sealed by a removable fill cap 208 and to drain the reservoir cavity, a drain plug 209 can be disposed toward the bottom of the reservoir.

The header assembly 202 accommodates the inlet and outlet tubes for directing fluids to and from the reservoir volume 204. For example, to supply reductant to the SCR process via the reductant injector 124 and pump 128 (FIG. 1), the header assembly 202 includes a reductant supply port 210 disposed externally of the reservoir 200 and which forms part of a reductant supply tube 212 directed into the reservoir volume 204. To ensure the supply tube 212 has access to the reductant, the supply tube may extend to a sump 214 located at the bottom of the reservoir volume 204. The sump 214 may include an inlet filter 216 to remove debris and contaminants from the fluid reductant before it enters the supply tube 212. Likewise, to receive excess reductant that may be returned from the SCR process, the header assembly 202 may include a reductant return port 218 that can discharge returning reductant proximate the top of the reservoir volume 204. In an embodiment, to measure the quantity of reductant in the reservoir 200, a reductant level sensor 220 slidably disposed on a sensor rod 222 can be installed in the reservoir volume 204 extending coaxially around and parallel to the supply tube 212. The reductant level sensor 220 can float on top of the fluid reductant and make readings or measurements with respect to the sensor rod 222 that indicate the reductant quantity.

Because the machine on which the reservoir 200 is included may be exposed to very cold, outdoor temperatures, the header assembly 202 can accommodate a heater device 230 to prevent the fluid reductant from freezing. In the illustrated embodiment, the heater device 230 can be a liquid-to-liquid heat exchanger that uses heat provided by a flow of warm engine coolant to thaw frozen reductant fluid in the reservoir 200. Although a coolant-operated heater is shown, other types of heaters such as electrically powered or exhaust-gas heat powered heaters, to name a few, may be used. The coolant-operated heater includes a coolant inlet conduit 232 that supplies warmed coolant from an engine, for example, the engine 102 (FIG. 1), to a helical element or tubular heater coil 234, which is disposed within the reservoir volume 204 and in contact with the reductant therein. Coolant provided through the coolant inlet conduit 232 passes through the heater coil 234, thus heating the reductant. From the heater coil 234, the flow of coolant may return to the engine through a coolant outlet conduit 236.

To insert the header assembly 202 and the tubes it accommodates into the reservoir 200, a header opening 240 can be disposed through the top of the reservoir body that provides access to the reservoir volume 204. In the embodiment best illustrated in FIGS. 2 and 3, the header opening 240 can be disposed through a reservoir embossment 242 of thicker or reinforced material formed on the external surface of the reservoir 200. The intersection of the header opening 240 and the upper surface of the reservoir embossment 242 can delineate a reservoir rim 246 that forms a shoulder-like structure on the body of the reservoir 200. To cooperatively mate with the header opening 240, the header assembly 202 can include a header 250 having a header flange 252 and a header boss 254 protruding or extending from the header flange. The header 250 may be made of molded plastic or machined metal and fixes the location of the inlet and outlet tubes disposed through it when installed in the header opening 240. In the illustrated embodiment, the header flange 252 and the header boss 254 may be circular in shape and may have a flange diameter and a boss diameter, respectively, with the boss diameter being less than the flange diameter. The circular header flange 252 and header boss 254 may be concentric about and delineate longitudinal axis line 255 which the supply tube 212 and heater coil 234 are disposed along. However, in other embodiments, other shapes for the header flange and boss are possible. When installed on the reservoir 200, the header flange 252 can be supported on the shoulder formed by the reservoir embossment 242 externally of the reservoir and the header boss 254 can be received into the header opening 240 such that the supply tube 212, sensor rod 222, and heater device 230 descend into the reservoir volume 204. The shoulder formed by the reservoir embossment 242 can have a circular shape with a diameter corresponding to that of the header flange 252 and the header opening 240 and the reservoir rim 246 it defines can be circular and have a diameter slightly less than that of the reservoir opening and dimensioned to form a sliding fit with the header boss 254. The header assembly 202 is thus the primary conduit for fluid communication into and out of the reservoir 200. The header assembly 202 may be removably mounted to the reservoir 200 by a plurality of threaded fasteners 244 that can pass through the fastener bores 256 in the header 250 and thread into complementary threaded holes in the reservoir embossment 242. To remove debris, contaminants, or ice suspended in the reductant and to protect the extended supply tube 212 and heater device 230, a filtration assembly 260 including a bag-like filter 262 can be secured to the underside of the header assembly 202 and descend into the reservoir volume 204.

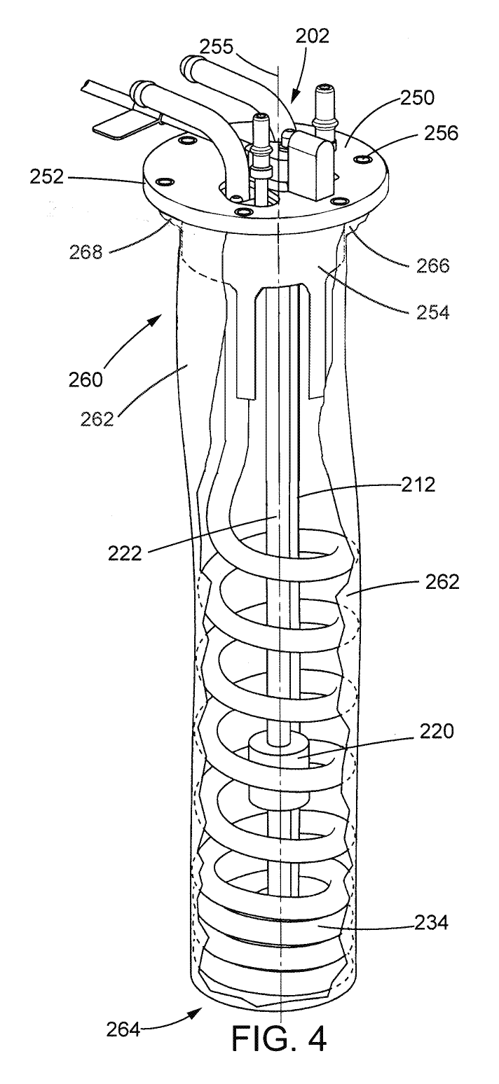

Referring to FIG. 4, the filtration assembly 260 and method of securing it to the header assembly 202 is better illustrated. In an aspect of the disclosure, the bag filter can be attached direct to the header assembly in a manner that effectively isolates the interior of the bag filter from the reservoir volume when it is installed in the reservoir volume. The bag filter 262 may have a tubular, sleeve- or sock-like configuration of flexible or pliable material that is elongated and extends coextensively with the supply tube 212 and the heater device 230 to surround and enclose them. To provide the tubular shape, the bag filter 262 can have a closed end 264 and an oppositely disposed opened end that delineates a mouth or bag opening 266 opposite the closed end. In an embodiment, the material of the bag filter can include supports or stitching to assist maintaining the tubular shape. The bag filter 262 can be made of a layer of polypropylene felt fabric or material, having a porosity of about 30 μm to 40 μm. The porosity of the bag filter 262 depends on the size of the debris expected to be present in the reservoir, and can change accordingly to be any size, although it may generally be expected for the porosity to be between 1 μm and 50 μm. As shown, the polypropylene felt has an inner, glazed side, and an outer, untreated or unglazed side with a felt feel, which increases the external area of the filter for trapping debris that may be moving around within the reservoir volume but that does not introduce loose fibers or debris from the filter on the internal, filtered side thereof. In certain embodiments, fabrics having both sides glazed may be used. Moreover, the polypropylene material may be replaced by a different material that is resistant to the type of fluid that will be filtered. Even further, although a single layer material is shown here for the bag filter 262, multiple layers or plies can be used. In one contemplated embodiment, two or more plies are used to increase filter efficiency. Regarding the construction of the bag filter 262, a flat sheet of fabric may be cut and sewn into the appropriate shape. Alternatively, the filter may be woven into a tubular shape by use of a sock knitting-type machine using polypropylene fibers and yarn.

When secured to the header assembly 202, the sock-like configuration of the bag filter 262 may define an internal cavity or void dimensionally corresponding to the heater coil 234 of the heater device 230. Hence, when installed over the heater device 230, the heater coil 234 expands the bag filter 262 and keeps it from collapsing under the influence of reductant flow being drawn into the supply tube 212 for removal from the reservoir. This also prevents the bag filter from being drawn into and choking of the supply tube 212 and from interfering with the reductant level sensor 220 disposed on the sensor rod 222. During operation, the fluid reductant can flow or permeate through the bag filter 262 from the surrounding reservoir volume 204 (FIG. 3) to access the supply tube 212, thereby filtering and removing debris and contamination from the reductant. The heater coil 234 may also keep the bag filter 262 from collapsing around and interfering with the reductant level sensor 220 on the sensor rod 222 that can be concentrically located within the helical heater coil. Hence, the bag filter 262 is prevented from interfering with the reductant quantity measurements.

To secure the filtration assembly 260 to the header assembly 202, the bag opening 266 an be generally circular in shape and have a diameter corresponding to the header boss 254. To install the filtration assembly 260 to the header assembly 202, the bag opening 266 can receive and concentrically surround the header boss 254 with the supply tube 212, sensor rod 222, and heater coil 234 inserted into the interior void of the bag filter 262. After insertion, the bag opening 266 can be disposed adjacent to the intersection of the header flange 252 and the header boss 254 such that the bag filter 262 abuts the underside of header flange. In addition, the pliable bag filter 262 may include additional or added material, or an added bag portion 268, disposed at the bag opening 266 that gathers or bunches at the underside of the header flange 252. Hence, the added bag portion 268 is disposed adjacent to the larger diameter header flange 252 and concentrically surrounds the smaller diameter header boss 254 when the bag filter 262 is installed on the header assembly 202. The added bag portion 268 may be of the same material as the rest of the bag filter 262 and may have the same pliable or flexible characteristics. The added bag portion 268 can be provided by extending the length of the bag filter 262 a short distance and allowing the additional length to generally project radially outward with respect to the diameter of the bag opening 266.

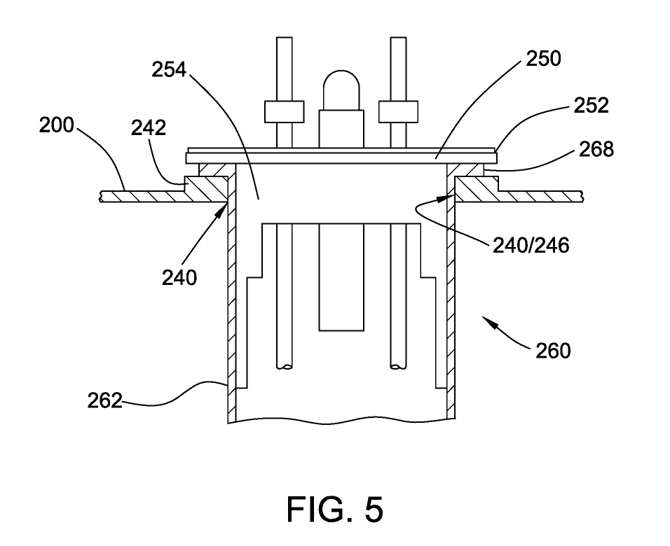

Referring to FIG. 5, an advantage of the added bag portion 268 is that, when the header assembly 202 is installed in the reservoir 200, the added material is sandwiched and compressed between the interface of the header flange 252 and the reservoir embossment 242, thereby providing a horizontally oriented seal between the two components. Further, when the header assembly 202 is secured to the reservoir 200, the header assembly and the reservoir embossment 242 cooperate to clamp and capture the added bag portion 268 at the interface and hold the bag filter 262 so that it remains suspended within the reservoir volume 204. Additionally, the tubular portion of the bag filter 262 proximate to the bag opening 266 can descend between the header opening 240 disposed in the reservoir embossment 242 to form the reservoir rim 246 and the header boss 254 protruding from the header flange 252. The header opening 240 and the header boss 254 can be dimensioned to provide a slight clearance gap and can compress the material of the bag filter 262 disposed therebetween against the reservoir rim 246 to provide a further sealing function. Because the material of the bag filter 262 is disposed at substantially all areas of interface between the reservoir 200 and the header assembly 202, such that the two components do not make direct contact, the reservoir volume 204 is effectively isolated from the interior void enveloped inside the bag filter and debris in the reductant is impeded from accessing the supply tube 212.

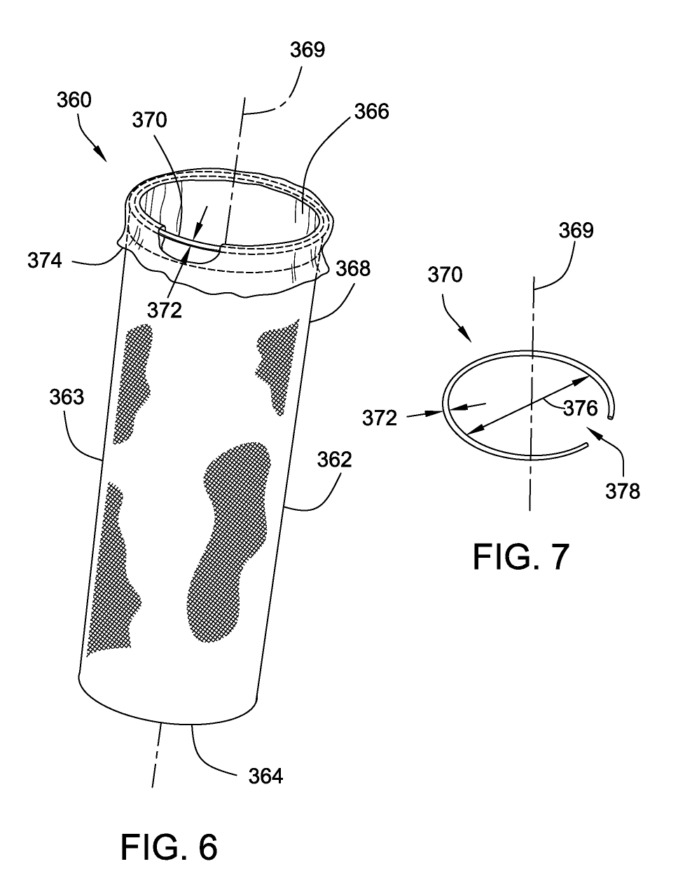

The foregoing embodiment in which the added bag portion 268 is compressed between the header assembly 202 and the reservoir embossment 242 may be difficult to install, especially if the bag filter 262 slides off the header boss 254 before installation is complete. Additionally, the sharp corner at the intersection of the cylindrical header opening 240 and the upper surface of the reservoir embossment 242 may rip or tear the material of the bag filter 262. To facilitate installation of the filtration assembly 260 in a reservoir, another embodiment of a filtration assembly 360 including a bag filter 362 is illustrated in FIG. 6. The filtration material of the bag filter 362 of the present embodiment can have a tubular, sock- or sleeve- configuration including filter sock 363 having a closed end 364 and an oppositely oriented opened end that delineates a bag opening 366 with an elongated tubular portion 368 extending between the closed end and the bag opening. The tubular portion 368 may delineate an internal cavity or void and an axis line 369 which the tubular portion surrounds and encloses. The filtration material of the bag filter 362 can be any of the aforementioned types of pliable or flexible filter materials including, for example, polypropylene felt material.

To secure the filtration assembly 360 to the header boss protruding from the header assembly during installation, the bag filter 362 can include a support ring 370 made of a thin annular band 372 of relatively rigid material, compared to the pliable filtration material, that desirably has a resilient characteristic. For example, in various embodiments, the support ring 370 can be made of metal or plastic. The diameter of the support ring 370 may dimensionally correspond to the diameter of the bag opening 366 and the cross-section of the band 372 can be selected from the group consisting of round, oval, and rectangular. To secure the support ring 370 to the filter sock 363, the bag filter 362 can include an additional extension of filtration material extending from the periphery of the bag opening 366. The support ring 370 can be disposed proximately to the bag opening 366 and oriented to circumferentially extend around and surround the exterior of the material extension which may be folded radially outwardly and back over the support ring to provide a hem 374. When so arranged, the hem 374 folds over and encloses the band 372 so the support ring 370 is captured proximate to the bag opening 366. However, in other embodiments, the support ring 370 can be disposed inside of the filter sock 363 and the hem 374 can be folded radially inwardly. The hem 374 can completely circumscribe the entire bag opening 366 so the support ring is entirely enclosed within the hem. The folded over portion of the hem 374 may be circumferentially secured to the tubular portion 368 of the filter sock 363 by stitching, sewing, adhesive, or the like, or in those embodiments in which the filtration material is plastic the hem may be secured to the tubular portion by localized melting or welding.

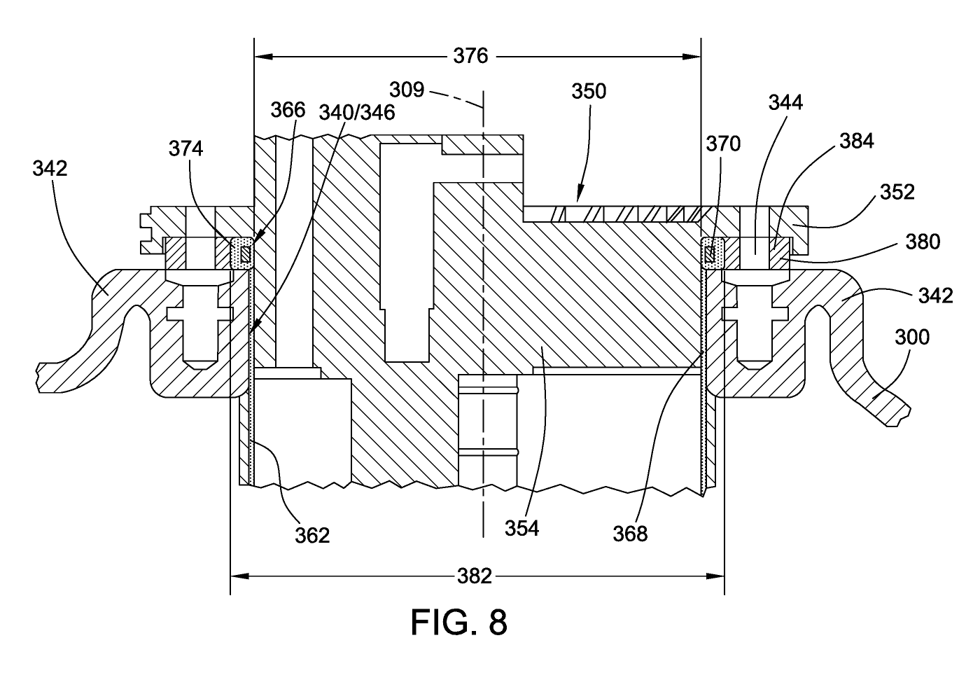

Referring to FIG. 7, the support ring 370 can be designed to grip around the header boss to hold the filtration assembly 360 secure to the header assembly. In particular, the support ring 370 can have a ring diameter 376 that is dimensioned slightly less than the corresponding outer diameter of the header boss. In addition, the support ring 370 can include a radial gap 378 that is disposed radially through a section of the band 372 that circumscribes that axis line 369. The radial gap 378 can make up only a few degrees of the 360° support ring 370 but enables the support ring to radially compress and expand with respect to the axis line 369. Referring to FIG. 8, to install the present embodiment of the bag filter 362 in the reservoir 300, the protruding header boss 354 initially can be inserted into the circular bag opening 366. Because the ring diameter 376 of the support ring 370 may smaller than the boss diameter associated with the header boss 354, the support ring must radially expand with respect to the axis line 369 as enabled by the radial gap disposed in therein. In an embodiment, the bag opening 366 and the support ring 370 secured therein can be disposed adjacent to the intersection of the larger diameter header flange 352 and the smaller diameter header boss 354 protruding from the header flange. The resilient characteristic of the support ring 370 causes the smaller diameter ring to compress around the circular header boss 354 at the illustrated location so that the bag filter 362 is attached to the header 350 with the filter sock 363 extending downward from the header flange 352. In an embodiment, a circumferential groove can be disposed into the cylindrical exterior surface of the header boss 354 to receive the support ring 370 disposed inside the hem 374 in a snap-fit manner.

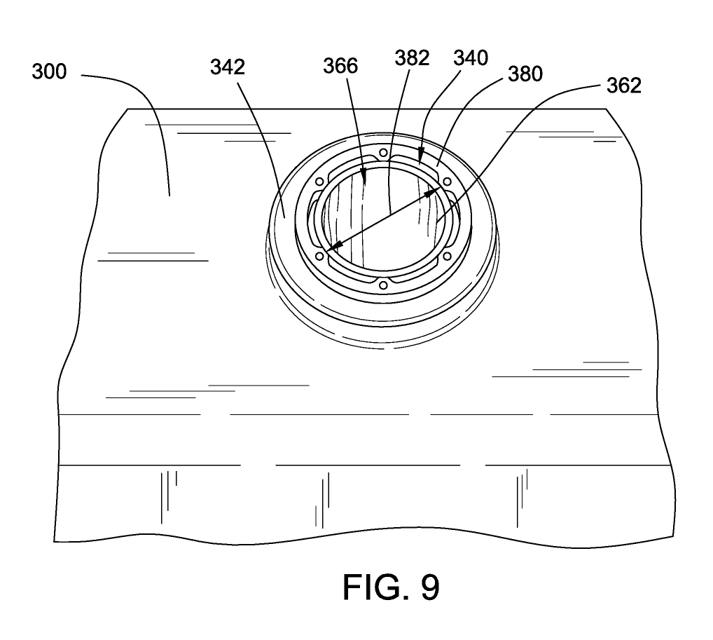

To install the header assembly 302 with the bag filter 362 secured thereto on the reservoir 300, the header boss 354 is inserted into the header opening 340 disposed into the reservoir embossment 342 on the exterior of the reservoir. The intersection of the header opening 340 and the upper surface of the reservoir embossment 342 may delineate a reservoir rim 346 which is comparable in size to the bag opening 366 and the support ring 370 so that the bag opening is prevented from passing through the header opening. The bag opening 366 and the support ring 370 disposed therein may be sandwiched and compressed at the interface between the upper surface of the reservoir embossment 342 and the underside of the header flange 352. In the embodiments in which the hem encloses the support ring, filtration material therefore is present at potentially every interface between the header assembly and the reservoir. Also, the tubular portion 368 of the filter sock 363 extends between the circular header opening 340 and the correspondingly shaped header boss 354 and may be partially compressed therebetween. Accordingly, in the present embodiment, the interior cavity of the bag filter 362 is isolated from the rest of the reservoir volume 304 such that debris is impeded from entering the interior of the bag filter. Referring to FIGS. 8 and 9, to further seal the reservoir volume 304 and to accommodate potential effects of thermal expansion and contraction, in an embodiment, an annular gasket 380 can be included which is disposed between the header 350 and the reservoir 300. The annular gasket 380 can have a gasket diameter 382 that is dimensioned equal to or larger than the ring diameter 376 and the corresponding diameter of the bag opening 366. According, the annular gasket 380 can be seated adjacent to the upper surface of the reservoir embossment 342 circumscribing the bag opening 366 prior to installation of the header assembly 302. Further, after installation, the annular gasket 380 is sandwiched and compressed between the reservoir embossment 342 and the header flange 352 to fortify the seal therebetween. The gasket diameter 382 of the annular gasket 380 can be dimensioned to radially constrain the bag opening 366 and the support ring 370 as those components are compressed between the reservoir embossment 342 and the header flange 352. Furthermore, the fasteners 344 that secure the header assembly 302 to the reservoir 300 may pass through fastener bores 384 disposed through and radially about the annular gasket 380. The annular gasket can be made from any suitable gasket material including, for example, cork that may assist sealing if the fasteners 344 experience thermal expansion or contraction due to the material's relatively incompressible characteristic.

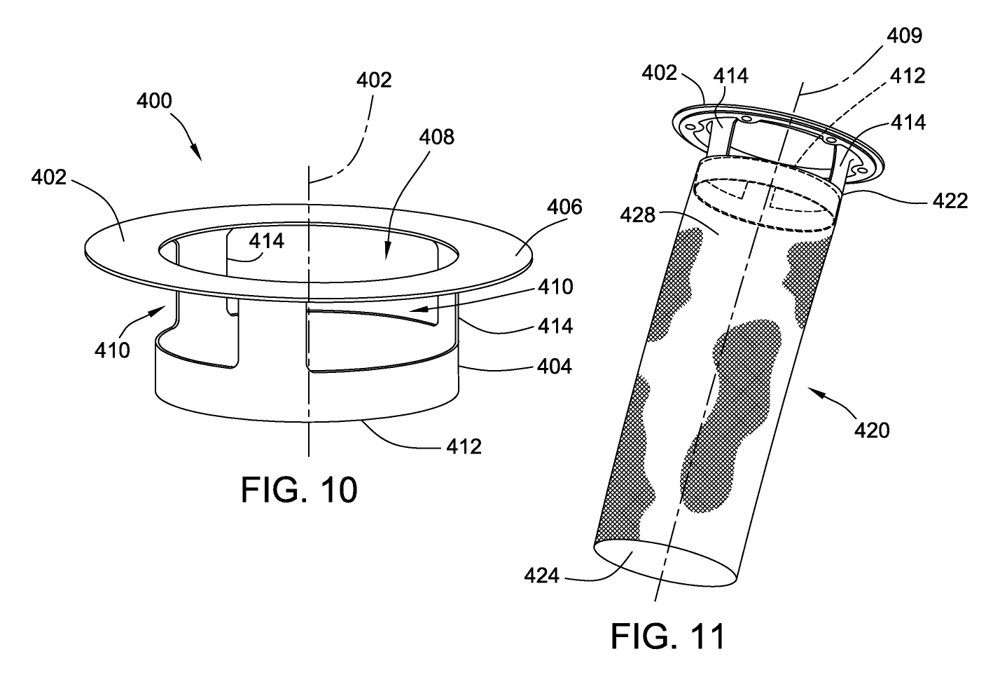

In a further embodiment, to facilitate retention of the bag filter within the reservoir volume, the bag filter can include a filter flange disposed proximate to the bag opening and which is adapted to be compressed between the header assembly and the reservoir embossment. Referring to FIGS. 10 and 11, the filter flange 400 can be a circular structure, roughly shaped as an upside-down top hat having a flat, annular flange 402 of a given width and with a cylindrical sleeve frame 404 attached at a first end to and depending perpendicularly from the inner diameter of the annular flange 402. The annular flange 402 and the sleeve frame 404 may be made from a thin, flexible plastic material. The annular flange 402 may have an flange diameter 416 at its outer periphery 406 that is larger than the sleeve diameter 418 of the sleeve frame 404. The sleeve frame 404 is generally cylindrical and defines a central bore 408 concentric to both the sleeve frame 404 and to the annular flange 402 and which further delineates an axis line 409 for reference purposes. To provide further flexibility, the filter flange 400 can have a plurality of openings or windows 410, which may be generally rectangular in shape and curved partially about the axis line 409 as illustrated, that are disposed through the sleeve frame 404 proximately where the sleeve frame and the annular flange intersect. The windows 410 may not be coextensive with the height of the sleeve frame 404 so that a bottom ring 412 is formed at a second end of the sleeve frame that is spaced apart from the annular flange 402. To join the annular flange 402 and bottom ring 412, the sleeve frame 404 may further include a plurality of frame legs 414 extending between the components axially parallel with respect to the axis line 409 and that completes the outline of the windows 410. Referring to FIG. 11, the filter flange 400 is attached to and part of the bag filter 420. The bag filter 420 can be made from a pliable, flexible material and can have a bag-like or sock-like construction including a bag opening 422 and an opposing closed end 424 with a sleeve-like, tubular portion 428 extending between the bag opening and the closed end 424. To join the two components, the filter flange 400 is partially inserted into the bag opening 422 of the bag filter 420 so that the bag opening 422 and the bottom ring 412 are concentrically arranged and coextensive with each other. The bag opening 422 can be attached to the bottom ring 412 of the filter flange 400 by sewing, adhesive, sonic welding or the like. When attached, the bag filter 420 hangs from the bottom ring 412 with the bag opening 422 spaced below the annular flange 402 by the frame legs 414 so that the windows 410 remain uncovered.

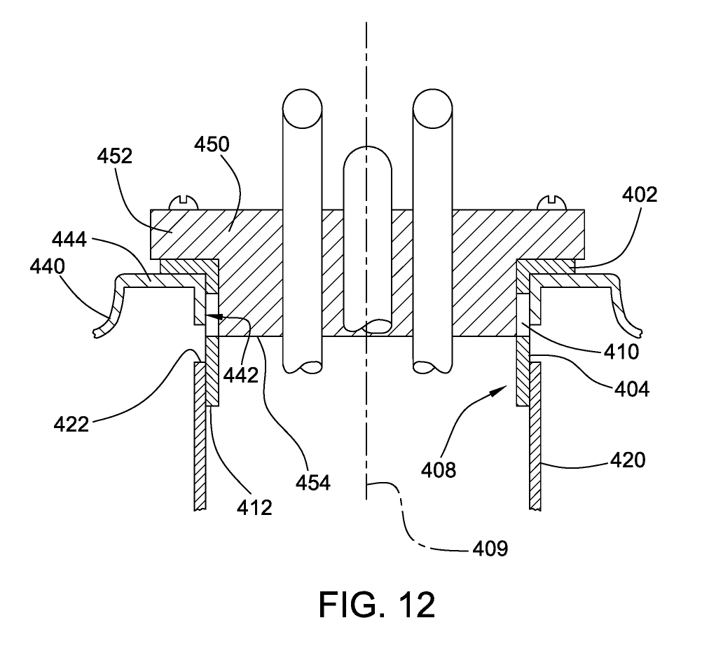

Referring to FIG. 12, to install the filter flange 400 and the attached bag filter 420 in the reservoir 440, the bag filter and flange filter are affixed to the header opening 442 disposed in the reservoir embossment 444 on the top of the reservoir. The filter flange 400 is sized so that the sleeve frame 404 can be inserted through the header opening 442 while the perpendicular annular flange 402 abuts against and is supported by the reservoir embossment 444. The windows 410 disposed in the sleeve frame 404 may facilitate insertion by enabling the filter flange 400 to flex and distort as the sleeve frame is pushed through the header opening 442. The material of the filter flange 400 may have a degree of resiliency or shape memory so that the sleeve frame 404 recovers its initial cylindrical shape after insertion. The length of the sleeve frame 404 is such that the bag opening 422 is disposed below the header opening 442 and will not interfere with the sliding abutment between the sleeve frame 404 and the header opening 442. When the header 450 is installed on the reservoir 440, the header flange 452 is placed adjacently over the reservoir embossment 444 and thereby sandwiches and compresses the annular flange 402 of the filter flange 400 therebetween. The header boss 454 is partially disposed through the header opening 442 and extends into the central bore 408 defined by the sleeve frame 404 to force the sleeve frame outwardly against the header opening 442. To prevent reductant from bypassing the bag filter 420, which terminates at the bag opening 422 circumferentially disposed around the bottom ring 412, the header boss 454 can be dimensioned to extend proximate the lower edge of the windows 410. The header boss 454 can therefore block any reductant from transferring through the window 410 and into the interior of the bag filter 420.

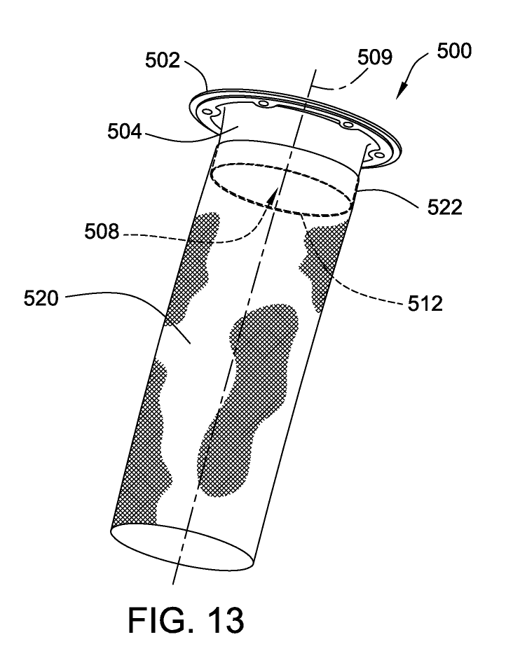

Referring to FIG. 13, there is illustrated another embodiment of the filter flange 500 having an upside down top hat shape and attached as part of the bag filter 520 proximate the bag opening 522. The filter flange 500 again includes an flat, annular flange 502 and a cylindrical sleeve frame 504 extending perpendicularly from the inner diameter of the annular flange. The sleeve frame 504 can extend to and terminate at bottom ring 512 that is spaced apart from annular flange 502. The annular flange 502 and the cylindrical, tubular sleeve frame 504 delineate and concentrically surround a central bore 508. The annular flange 502 and the sleeve frame 504 can also be made from thin, semi-pliable plastic material so that the filter flange 500 can be distorted during insertion into the reservoir. When attached to the bag filter 520, the cylindrical sleeve frame 504 can expand the bag opening 522 and help the bag filter maintain its sleeve-like configuration. In contrast to the filter flange of FIGS. 10 and 11, the illustrated filter flange 500 lacks windows and the sleeve frame 504 is formed as a continuous cylindrical surface corresponding in diameter to the header boss that it receives when installed in the reservoir. Eliminating the windows also eliminates the potential leak paths that may be created if the header boss does not align precisely with windows. To enable insertion of the filter flange 500 into the reservoir, the material may relatively thin to add pliability. In a further embodiment the sleeve frame 504 may include corrugation or flex point that allow it to distort in shape to further facilitate insertion.

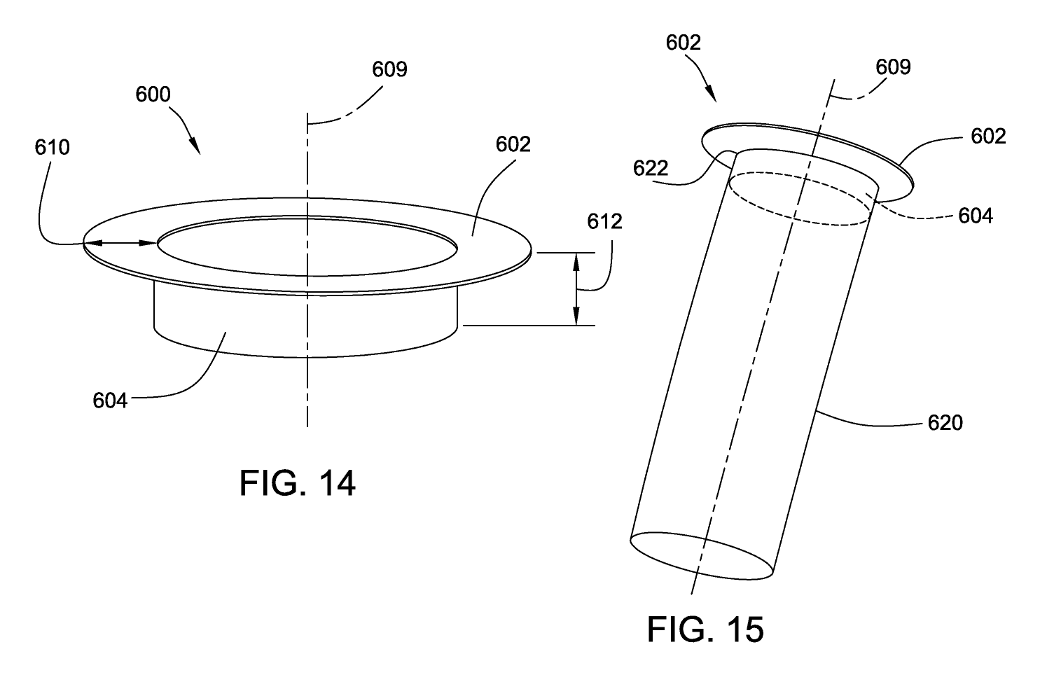

Referring to FIGS. 14 and 15, there is illustrated another embodiment of a filter flange 600 generally shaped as a top hat for installing bag filter 620 within a reservoir. Similar to the previous embodiments of the filter flange, the illustrated embodiment includes a flat, annular flange 602 and a cylindrical, tubular sleeve frame 604 that extends perpendicularly from the inner diameter of the annular flange 602. The circular shape of the annular flange 602 and the cylindrical sleeve frame 604 further delineate an axis line 609. Similar to the embodiment of FIG. 13, the sleeve frame 604 may be a continuous surface without any windows or apertures disposed through it. Further, the filter flange 600 can be made from thin, flexible plastic material to facilitate installation. In contrast to the previous embodiment, the sleeve frame 604 may be relatively short extending from the annular flange 602 only a short distance. For example, if the annular flange 602 has a flange width 610 of a predetermined dimension, the sleeve frame 604 may have a frame length 610 that is equal to or shorter than the flange width. The bag opening 622 of the bag filter 620 can be attached either inside or outside of the shorter sleeve frame 604 which assists in maintaining the tubular opened shape of the bag filter. In the illustrated embodiment, the bag filter 620 may be attached so that the bag filter and the sleeve frame 604 both extend in a first axial direction along the axis line 609 with respect to the annular flange 602. The bag filter 620 can be secured to the filter flange 600 by any of the foregoing methods including, for example, welding and stitching.

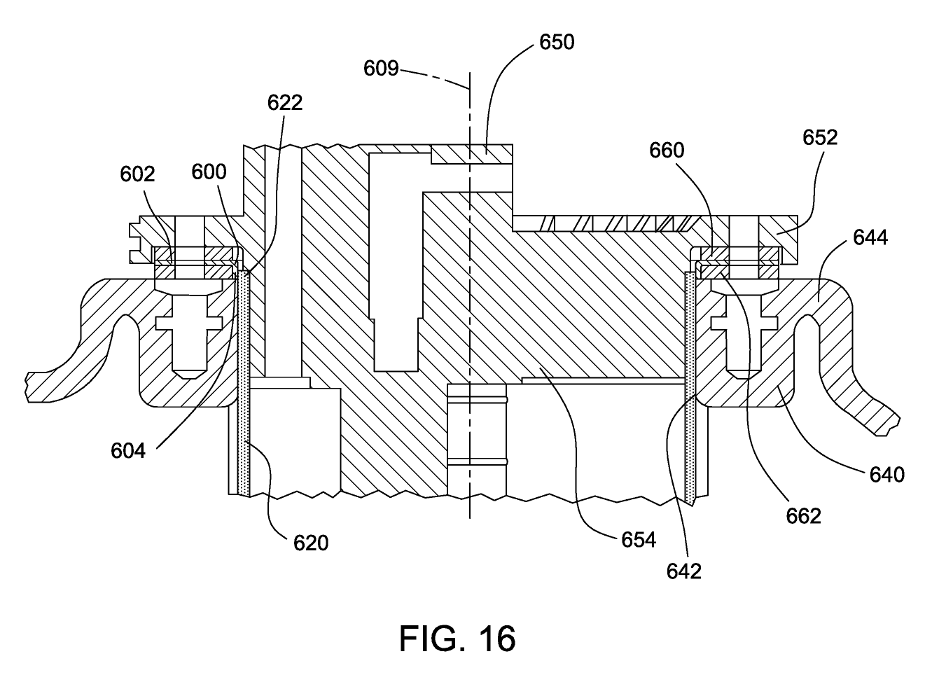

Referring to FIG. 16, there is illustrated an embodiment of the filter flange 600 and the bag filter 620 installed in the reservoir 640. The annular flange 602 is disposed over the upper surface of the correspondingly dimensioned annular reservoir embossment 644 concentric to the header opening 642 disposed through the reservoir. The filter flange 600 can be arranged so that the sleeve frame 604 descends into the header opening 642 and supports the bag filter 620 in a suspended position. When the header 650 is installed on the reservoir 640, the header flange 652 sandwiches and compresses the annular flange 602 and the header boss 654 can be inserted into the bag opening 622 to radially expand the bag filter 620 outwardly against the header opening 642. In the illustrated embodiment, the inner diameter of the filter flange 600 may be dimensioned so the sleeve frame 604 is disposed radially outward of the header opening 642 and only the bag filter 620 contacts the header boss 654. In a further embodiment, to further improve the seal between the reservoir embossment 644 and the header flange 652, upper and lower annular shaped gaskets 660,662 may be disposed above and below the annular flange 602 of the filter flange 600.

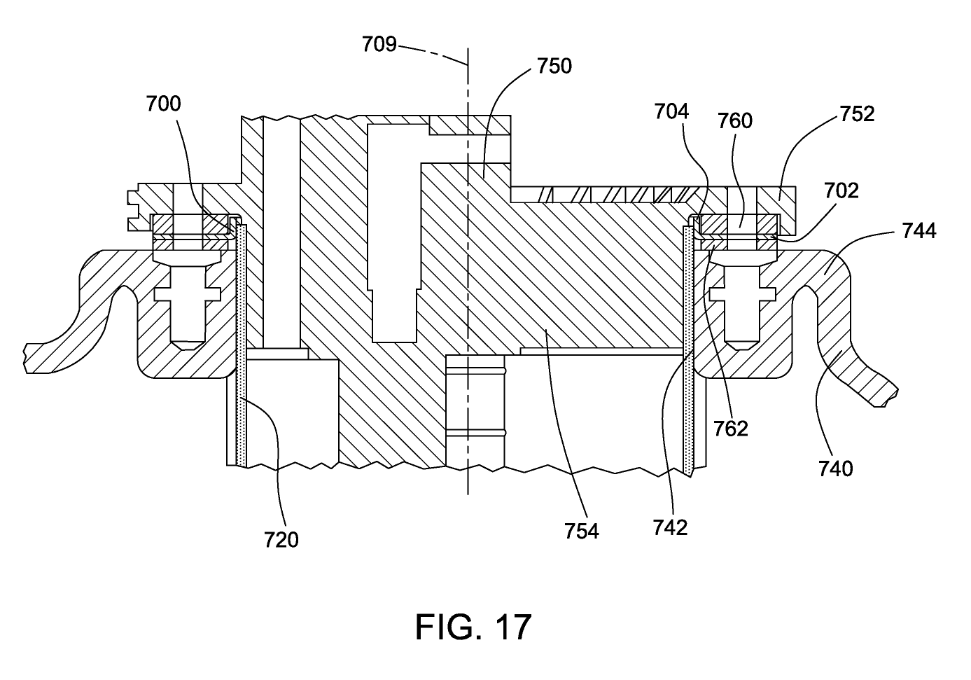

Referring to FIG. 17, there is illustrated another embodiment of the filter flange 700 similar to the top hat shape and arrangement of the filter flange of FIG. 16 having an annular flange 702 with a shorter sleeve frame 704 depending perpendicularly from the annular flange. The bag filter 720 can be attached to the inside diameter of the sleeve frame 704 according to any of the aforementioned methods. The arrangement differs from FIG. 16 with respect to the orientation of the sleeve frame 704 when installed on the reservoir 740. In particular, the sleeve frame 704 may extend in a first axial direction with respect to the annular flange and the bag filter 720 may extend in a second axial direction opposite the first axial direction. When installed, the annular flange 702 is disposed and compressed between the upper surface of the reservoir embossment 744 and the underside of the header flange 742 of the header 750 with the sleeve frame 704 oriented away from the reservoir embossment 744 and toward the header. The sleeve frame 704 is concentric to the header opening 742 and may have substantially the same diameter as the header opening but extends axially upward from the intersection of the header opening and the upper surface of the reservoir embossment 744. Accordingly, the orientation of the sleeve frame 704 upwardly away from the reservoir embossment 744 lifts a portion of the bag filter 720 out of the header opening 742. The filtration material of the bag filter 720 therefore isolates the intersection between the header opening 742 disposed in the reservoir 740 and the header 750. In an embodiment, to further improve the seal between the reservoir embossment 744 and the header flange 752, upper and lower annular shaped gaskets 760,762 may be disposed above and below the annular flange 702 of the filter flange 700.

### INDUSTRIAL APPLICABILITY

The present disclosure is applicable to emission control systems for engines and, more particularly, to emission control systems using SCR processes requiring the injection of fluid reductant like urea-based water solutions into engine exhaust streams. In the disclosed embodiments, a bag filter is configured to disposed proximate to the intersection of a reservoir opening and a header assembly that is installed in the reservoir opening to effectively isolate the reservoir volume from the interior cavity of the bag filter which encloses the supply through which reductant is drawn from the reservoir, which is advantageously configured to provide sufficient protection from debris, such as silt, dirt, fibers and the like, or transient debris such as ice, from entering into a pumping system and/or otherwise clogging flow passages out from the reservoir.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

We claim:

1. A bag filter disposable in a reservoir for filtration of a liquid reductant contained in the reservoir, the bag filter comprising:
a support ring of relatively rigid material; and
a filter sock of filtration material having relatively pliable characteristic, the filter sock having an elongated configuration including a closed end, an opened end disposed opposite the closed end, and a tubular portion extending between the closed end and the opened end; wherein
the opened end delineates a bag opening and includes a hem of filtration material folded over the support ring and attached to the tubular portion.

2. The bag filter of claim 1, wherein the support ring includes a radial gap so that the support ring extends less than 360° enabling the support ring to radially compress and expand.

3. The bag filter of claim 2, wherein the hem is attached to the tubular portion by stitching.

4. The bag filter of claim 3, wherein the support ring is composed of a material selected from a group consisting of metallic and plastic.

5. The bag filter of claim 4 wherein a cross-section of the support ring is selected from a group consisting of round, oval, and rectangular.

6. The bag filter of claim 5, wherein the filter sock is made of polypropylene felt material.

7. The bag filter of claim 6, wherein the filter sock is of a multi-ply construction.

8. A reservoir for liquid reductant comprising:
a reservoir body delineating a reservoir volume, the reservoir body including a header opening for receiving a header and delineated by a reservoir rim that forms a shoulder-like structure surrounding the header opening;
a header assembly including a header having a header flange and a header boss protruding from the header flange, the header boss corresponding in shape to and receivable in the header opening;
a bag filter including a support ring and a filter sock of filtration material, the filter sock having a closed end and an opened end delineating a bag opening, the bag opening including a hem of filtration material folded over the support ring and attached back to itself; wherein
the support ring and the bag opening are configured to fit closely about the header boss for disposal between the reservoir rim and the header flange.

9. The reservoir of claim 8, wherein the header opening is circular and has an opening diameter that delineates an axis line, and the header boss is circular and has a boss diameter slightly less than the opening diameter.

10. The reservoir of claim 9, wherein the support ring includes a radial gap so that the support ring extends less than 360° enabling the support ring to radially compress and expand with respect to the header boss.

11. The reservoir of claim 10, wherein the support ring has a ring diameter that is equal to or less than a diameter of the header boss.

12. The reservoir of claim 11, further comprising an annular gasket disposed between the reservoir and the header flange, the annular gasket circumscribing the header opening and the bag opening.

13. The reservoir of claim 12, wherein the annular gasket has a gasket diameter equal to or larger than the ring diameter.

14. A filter flange/bag filter combination insertable in a reservoir for reductant fluid, the bag filter/filter flange comprising:
a filter flange including a sleeve frame cylindrical in shape extending between a first end and a second end and delineating central bore and an axis line, the filter flange further including an annular flange extending perpendicularly from the first end of the sleeve frame and concentric to the central bore; and
a bag filter of pliable filtration material and having a closed end and an opened end disposed opposite the closed end, the opened end delineating a bag opening and attached to the sleeve frame.

15. The filter flange/bag filter combination of claim 14, wherein the sleeve frame includes a bottom ring proximate the second end disposed axially opposite the first end and the opened end of the bag filter is attached proximate to the second end and spaced apart from the annular flange.

16. The filter flange/bag filter combination of claim 15, wherein the filter flange further includes a plurality of windows disposed through the sleeve frame and are outlined by a plurality of frame legs extending between the first end and the second end.

17. The filter flange/bag filter combination of claim 14, wherein the sleeve frame forms a continuous cylindrical surface between the first end and the second end.

18. The filter flange/bag filter combination of claim 14, wherein the sleeve frame includes an axial length and the annular flange includes a radial width, the axial length less than the radial width.

19. The filter flange/bag filter combination of claim 14, wherein the sleeve frame extends in a first axial direction with respect to the annular flange and the bag filter extends in a second axial direction opposite the first axial direction.

20. The filter flange/bag filter combination of the claim 14, wherein the sleeve frame and the bag filter both extend in a first axial direction with respect to the annular flange.
